(19) United States
(12) Patent Application Publication
(10) Pub. No.: US 2025/0155047 A1
(43) Pub. Date: May 15, 2025

(54) Solenoid Valve Assembly for a Vehicle Dynamics System

(71) Applicant: Robert Bosch GmbH, Stuttgart (DE)

(72) Inventors: Peter Kralicek, Marbach (DE); Andreas Schmidtlein, Tamm (DE); Jochen Huebl, Schwieberdingen (DE)

(21) Appl. No.: 18/838,542

(22) PCT Filed: Jan. 31, 2023
(86) PCT No.: PCT/EP2023/052242

§ 371 Date: Aug. 14, 2024

(30) Foreign Application Priority Data
Feb. 16, 2022 (DE) 10 2022 201 580.0

(51) Int. Cl. F16K 31/06; B60T 13/68

(52) U.S. Cl. CPC F16K 31/0675; B60T 13/686

(57) ABSTRACT

A solenoid valve assembly for a vehicle dynamics system includes a hydraulic block, a number of solenoid valves which each comprise a valve dome and a magnet assembly, and control electronics. The individual magnet assemblies each have a housing and a winding carrier located in the housing and onto which a coil winding connected to the control electronics via connection lines is wound. A free space is formed between the housing and the winding carrier of each individual magnet assembly. A filling device is designed to reduce the free space and to increase a coupling capacitance forming between the coil winding and the housing and the valve dome.

The invention relates to a solenoid valve assembly for a vehicle dynamics system. It is also an object of the present invention to provide a vehicle dynamics system including such a solenoid valve assembly.

In vehicle dynamics systems that perform vehicle dynamics control functions and/or brake control functions, solenoid valve assemblies with solenoid valves are used to regulate the pressure of a brake fluid for individual wheels or brake circuits. For this purpose, control signals are generated by control electronics and output to the solenoid valves of the solenoid valve assembly. The solenoid valves are usually screwed or pressed into a hydraulic block, which provides various hydraulic paths. In addition, a sensor system comprising at least one pressure sensor and a drive for a fluid pump can be connected to the hydraulic block. The control electronics generate parasitic, unwanted electromagnetic interference, some of which is conducted from the control electronics to a load, such as the pump drive, the solenoid valve, the sensor system, and can lead to increased EMC radiation (EMC: electromagnetic compatibility) in the vehicle via the connected brake lines. A common countermeasure is to feed these disturbances back from the hydraulic block with low impedance to the source, in this case the control electronics, so that these disturbances do not appear in the vehicle. This is usually solved with the help of mechanical contacting, which, however, must be developed at great expense. For example, springs or contact tongues, but also screw connections or contacts on the solenoid valves themselves can be used to create a low-impedance connection between the hydraulic block and the control electronics so that the interference can be fed back.

A housing assembly with improved electromagnetic compatibility is known from DE 10 2019 133 083 A1. Electrical modules in electrified vehicles, such as a battery pack, a control module, etc., may comprise a component, such as a battery assembly, a bus bar, a battery electrical control module, etc., and a housing assembly in which the component is enclosed. The housing assembly may include a polymer-based substrate and a metal foil adapted to enhance electromagnetic compatibility of the polymer-based substrate. A compression limiter may be positioned in an opening of the housing assembly and configured to provide a conductive path between the metal foil and a separate metal component, such as a fastener, of the electrical module.

### DISCLOSURE OF THE INVENTION

The solenoid valve assembly for a vehicle dynamics system with the features of independent claim 1 and the vehicle dynamics system for a vehicle with the features of patent claim 9 each have the advantage that at least one feedback path is created with the aid of modified magnet assemblies, so that the overall impedance between control electronics and a hydraulic block can be lowered and the overall EMC (electromagnetic compatibility) of the solenoid valve assembly and the corresponding vehicle dynamics system can be improved. The lower the impedance of this at least one feedback path between the hydraulic block and the control electronics, the more faults can be fed back from the hydraulic block to the control electronics and compensated for.

Embodiments of the present invention provide a solenoid valve assembly for a vehicle dynamics system comprising a hydraulic block, a plurality of solenoid valves each comprising a valve dome and a magnet assembly, and control electronics. The individual magnet assemblies each comprise a housing and a winding carrier located in the housing, on which a coil winding connected to the control electronics via connection lines is wound. A free space is formed between the housing and the winding carrier of each magnet assembly. Here, a filling device is designed to reduce the free space and increase a coupling capacitance forming between the coil winding and the housing and the valve dome.

In addition, a vehicle dynamics system with such a solenoid valve assembly is proposed.

For example, the solenoid valve assembly according to the invention can be used in vehicle dynamics control functions and/or brake control functions to feed back EMC interference from the hydraulic block to the control electronics and reduce or eliminate it.

The coupling impedance in the solenoid valve is capacitive. This means that increasing the coupling capacitance of the solenoid valve's magnet assembly causes a reduction in the solenoid valve's coupling impedance. Due to the signal frequencies of the interference from the control electronics, coupling capacitances in the picofarad range (pF range) are already sufficient to reduce the coupling impedance of the individual solenoid valves. The current design of solenoid valves is optimized to increase the coupling capacitance between the coil winding and the housing, which in this case is made of a magnetic and electrically conductive material, preferably a metal such as an iron alloy or steel, and the valve dome. The coupling capacitance of the magnet assembly is created between the coil winding and the inner and outer body or housing in which the coil winding is located.

In the present context, the control electronics can be understood as an electronic circuit comprising a printed circuit board and at least one electronic component for generating control signals and outputting them to the solenoid valves of the solenoid valve assembly. These control signals are usually provided as a current flow through a coil of the respective solenoid valve and result in a magnetic force that moves a movable armature inside a valve dome of the solenoid valve.

The hydraulic block can be a metal block, preferably made of aluminum, in which several hydraulic paths or hydraulic ducts and connection holes are provided. The solenoid valves or sensors, such as a pressure sensor or a temperature sensor, or hydraulic lines can be screwed or pressed into the individual locating holes. In addition, a drive for a fluid pump can be connected to the hydraulic block.

Advantageous improvements to the solenoid valve assembly for a vehicle dynamics system disclosed in independent claim 1 are possible by the measures and further developments set forth in the dependent claims.

It is particularly advantageous that the increased coupling capacitances of the magnet assemblies of the individual solenoid valves can each provide low-impedance feedback for interference signals from the hydraulic block to the control electronics, so that several electrically parallel feedback paths can be created between the hydraulic block and the control electronics. Since common vehicle dynamics and/or brake control systems usually have eight to twelve solenoid valves, a total coupling impedance of the feedback corresponds to a parallel connection of the coupling impedances of all solenoid valves. This parasitically creates eight to twelve coupling capacitances in the coil windings of the solenoid valves used. A total coupling impedance results from the parallel connection of the coupling impedances of the solenoid valves and in total results in a lower coupling impedance of the feedback path than only a spring or screw or clamp or plug connection of conventional solenoid valve assemblies.

In an advantageous embodiment of the solenoid valve assembly, the filling device may comprise a filling material having a predetermined permittivity which is much greater than 1. For example, adhesives, silicones, or heat-conducting media can be used as filling material, which can be introduced into the free space in liquid form and cured.

In an alternative embodiment of the solenoid valve assembly, the filling device may comprise a sleeve that may be inserted into the free space between the coil winding and the housing. This sleeve can, for example, be applied to a winding carrier after completion of the coil winding process. Preferably, the sleeve can be made of a plastic material whose permittivity is much greater than 1.

In yet another alternative embodiment of the solenoid valve assembly, the coil winding structure may be altered. Thus, an additional edge portion of the coil winding can increase an overall cross section of the coil winding and form the filling device. As a result, turns in the edge portion of the coil winding are very close to the housing, so that the free space can be reduced and the coupling capacitance significantly increased. For example, the additional edge portion of the coil winding may have a trapezoidal or rectangular cross-section. Furthermore, to further increase the coupling capacitance, in addition to changing the winding structure, a filling material with a predetermined permittivity, which is much greater than 1, can be introduced into the remaining free space.

In embodiments of the solenoid valve assembly according to the invention, the coupling capacitance of the individual solenoid valves is increased by design, for example by filling the free space between the coil winding and the housing or by changing the winding structure of the coil winding so that the clearance is minimal and the turns in the edge region of the coil winding are very close to the housing.

Exemplary embodiments of the invention are illustrated in the drawings and explained in greater detail in the subsequent description. In the drawings, identical reference numbers refer to components or elements performing identical or similar functions.

### BRIEF DESCRIPTION OF THE DRAWINGS

FIG. 1 shows a schematic sectional view of an exemplary embodiment of a solenoid valve assembly for a vehicle dynamics system according to the invention.

FIG. 2 shows a schematic sectional view of a first exemplary embodiment of a magnet assembly of a solenoid valve of the solenoid valve assembly according to the invention of FIG. 1.

FIG. 3 shows a schematic sectional view of a second exemplary embodiment of a magnet assembly of a solenoid valve of the solenoid valve assembly according to the invention of FIG. 1.

FIG. 4 shows a schematic sectional view of a third exemplary embodiment of a magnet assembly of a solenoid valve of the solenoid valve assembly according to the invention of FIG. 1.

### EMBODIMENTS OF THE INVENTION

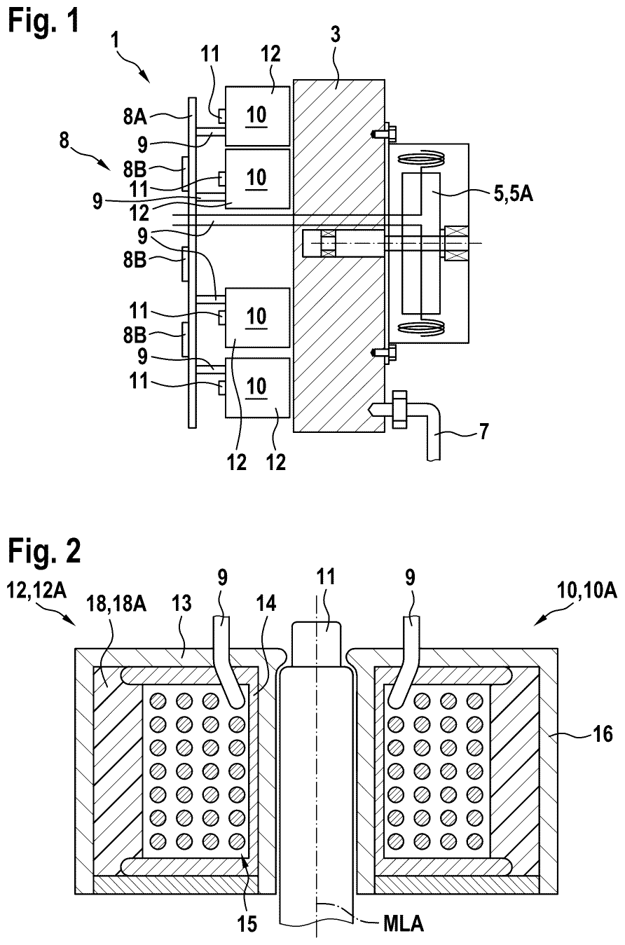

As can be seen from FIGS. 1 through 4, the illustrated exemplary embodiment of a solenoid valve assembly 1 for a vehicle dynamics system according to the invention comprises a hydraulic block 3, a plurality of solenoid valves 10, 10A, 10B, 10C, each comprising a valve dome 11 and a magnet assembly 12, 12A, 12B, 12C, and control electronics 8. The individual magnet assemblies 12, 12A, 12B, 12C each comprise a housing 13 and a winding carrier 14 located in the housing 13, on which a coil winding 15 connected to the control electronics 8 via connection lines 9 is wound. A free space 16 is formed between the housing 13 and the winding carrier 14 of each of the magnet assemblies—magnet assembly 12, 12A, 12B, 12C. Here, a filling device 18 reduces free space 16 and increases a coupling capacitance forming between coil winding 15 and housing 13 and valve dome 11.

The solenoid valve assembly 1 is preferably used in vehicle dynamics systems to perform vehicle dynamics control functions and/or brake control functions. As can be further seen from FIG. 1, the control electronics 8 in the illustrated exemplary embodiment comprises a printed circuit board 8A and several electronic components 8B to generate control signals and output them to the solenoid valves 10, 10A, 10B, 10C of the solenoid valve assembly 1 via connection lines 9. In the illustrated exemplary embodiment, these control signals are provided as a current flow through the coil windings 15 of the respective solenoid valve 10, 10A, 10B, 10C and result in a magnetic force that moves a movable armature, not shown in more detail, inside the valve dome 11 of the solenoid valve 10, 10A, 10B, 10C.

As can be seen further from FIG. 1, a drive 5 designed as an electric motor 5A for a fluid pump not shown in more detail is connected to the hydraulic block 3. The electric motor 5A is connected to the control electronics 8 via connection lines 9. In the exemplary embodiment shown, the hydraulic block 3 is designed as an aluminum block in which several hydraulic paths or hydraulic ducts and connection holes, which are not shown in more detail, are incorporated. The solenoid valves 10, 10A, 10B, 10C are pressed into the individual locating bores. In addition, hydraulic lines 7 are screwed into the hydraulic block 3, which connect, for example, wheel brakes not shown in more detail to the fluid ducts in the hydraulic block 3.

As can be further seen from FIG. 1, the magnet assemblies 12, 12A, 12B, 12C of four solenoid valves 10, 10A, 10B, 10C are visible in the section of solenoid valve assembly 1 shown. Here, the increased coupling capacitances of the individual magnet assemblies—magnet assembly 12, 12A, 12B, 12C—each cause low-impedance feedback for interference signals from hydraulic block 3 to control electronics 8, resulting in multiple electrically parallel feedback paths between hydraulic block 3 and control electronics 8.

As can be further seen from FIG. 2, in the illustrated first exemplary embodiment of the magnet assembly 12A for a solenoid valve 10A, the filling device 18 comprises a filling material 18A having a predetermined permittivity which is much greater than 1. In the illustrated exemplary embodiment, the filling material 18A is a silicone which, after the coil winding 15 has been applied to the winding carrier and the winding carrier 14 has been inserted into the hood-shaped steel housing 13, is introduced in liquid form into the free space 16 and cured. The hood-shaped housing 13 has a central feedthrough which at least partially encloses the valve dome 11. After the filling material 18A has been inserted, an annular bottom is pressed into the open end of the housing 13. The magnet assembly is then plugged or pressed onto the valve dome 11.

In alternative exemplary embodiments not shown, instead of silicone, an adhesive or heat-conducting medium or other suitable material may be introduced into the free space 16 as filling material 18A.

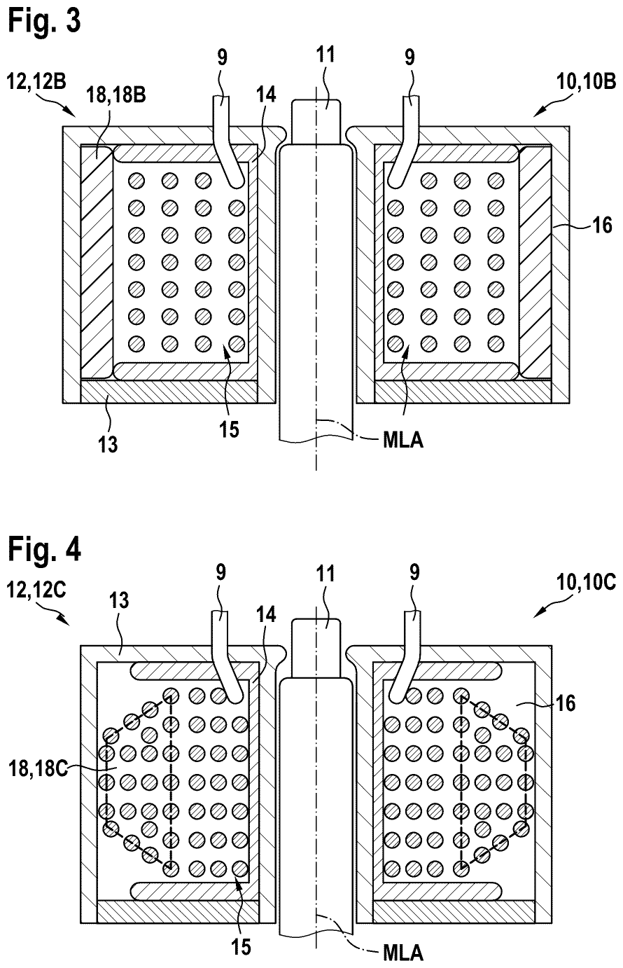

As can be further seen from FIG. 3, in the illustrated second exemplary embodiment of the magnet assembly 12B for a solenoid valve 10B, the filling device 18 comprises a sleeve 18B inserted into the free space 16 between the coil winding 15 and the housing 13. The sleeve 18B is made of a plastic material whose permittivity is much greater than 1.

As can be further seen from FIG. 4, in the illustrated third exemplary embodiment of the magnet assembly 12C for a solenoid valve 10C, the filling device 18 comprises a coil winding 15 having a modified winding structure. The coil winding 15 comprises an additional edge portion 18C, which enlarges an overall cross section of the coil winding 15 and forms the filling device 18. As can be further seen from FIG. 4, additional edge portion 18C of coil winding 15 in the illustrated exemplary embodiment has a trapezoidal cross-section shown in dashed lines. As can be further seen from FIG. 4, the additional edge portion 18C of the coil winding 15 protrudes at least partially from the winding carrier 14 and reduces the free space 16 between the coil winding 15 and the housing 13.

In an alternative exemplary embodiment of the magnet assembly 12 not shown, the additional edge portion 18C has a rectangular cross-section.

1. A solenoid valve assembly for a vehicle dynamics system, comprising:
a hydraulic block;
a number of solenoid valves which each comprise a valve dome and a magnet assembly; and
control electronics,
wherein the magnet assembly of each solenoid valve comprises a housing and a winding carrier, which is located in the housing and onto which a coil winding connected to the control electronics via connection lines is wound,
wherein a free space is formed between the housing and the winding carrier of the magnet assembly of each solenoid valve, and
wherein a filling device is configured to reduce the free space and to increase a coupling capacitance between the coil winding, the housing, and the valve dome.

2. The solenoid valve assembly according to claim 1, wherein the increased coupling capacitances of the magnet assemblies each effect low-impedance feedback for interference signals from the hydraulic block to the control electronics, such that a plurality of electrically parallel feedback paths are produced between the hydraulic block and the control electronics.

3. The solenoid valve assembly according to claim 1, wherein the filling device comprises a filling material having a predetermined permittivity which is much greater than 1.

4. The solenoid valve assembly according to claim 3, wherein the filling material is an adhesive, a silicone, or a heat-conducting medium introduced into the free space in liquid form and cured.

5. The solenoid valve assembly according to claim 1, wherein the filling device comprises a sleeve inserted into the free space between the coil winding and the housing.

6. The solenoid valve assembly according to claim 5, wherein said sleeve is made of a plastic material having a permittivity much greater than 1.

7. The solenoid valve assembly according to claim 1, wherein an additional edge portion enlarges an overall cross section of the coil winding and forms the filling device.

8. The solenoid valve assembly according to claim 7, wherein the additional edge portion of the coil winding has a trapezoidal or rectangular cross-section.

9. A vehicle dynamics system, comprising:
the solenoid valve assembly according to claim 1.
